(19) United States
(12) Patent Application Publication
(10) Pub. No.: US 2025/0350354 A1
(43) Pub. Date: Nov. 13, 2025

(54) EPHEMERIS DATA SIGNALING WITH EXTENSIONS INDICATING CELL COVERAGE

(71) Applicant: Telefonaktiebolaget LM Ericsson (PUBL), Stockholm (SE)

(72) Inventors: Johan Rune, LIDINGÖ (SE); Helka-Liina Määttänen, Espoo (FI); Sebastian Euler, STORVRETA (SE); Emre Yavuz, STOCKHOLM (SE)

(21) Appl. No.: 18/260,301

(22) PCT Filed: Dec. 22, 2021
(86) PCT No.: PCT/IB2021/062212

§ 371 Date: Jul. 3, 2023

Related U.S. Application Data
(60) Provisional application No. 63/135,290, filed on Jan. 8, 2021.

(51) Int. Cl. H04B 7/185

(52) U.S. Cl. CPC H04B 7/18547; H04B 7/1851; H04B 7/18539

(57) ABSTRACT

A method (1000) by a wireless device (110) is provided for determining cell coverage area provided by one or more satellites. The method includes receiving (1002) information at the wireless device. The wireless device uses (1004) the received information to obtain a location of the cell coverage area provided by the one or more satellites for a plurality of times.

### TECHNICAL FIELD

The present disclosure relates, in general, to wireless communications and, more particularly, systems and methods for ephemeris data signaling with extensions indicating cell coverage.

### BACKGROUND

In Third Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13, NB-IoT and LTE-M are part of the LTE specifications and provide connectivity to massive machine type communications (mMTC) services.

In 3GPP Release 15, the first release of the 5G system (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and to that add needed components when motivated by the new use cases.

In Release 15, 3GPP also started the work to prepare NR for operation in a Non-Terrestrial Network (NTN). The work was performed within the study item “NR to support Non-Terrestrial Networks” and resulted in 3GPP TR 38.811. In Release 16, the work to prepare NR for operation in an NTN network continues with the study item “Solutions for NR to support Non-Terrestrial Network.” In parallel, the interest to adapt LTE for operation in NTN is growing. As a consequence, 3GPP Release 17 contains both a work item on NR NTN and a study item on NB-IoT and LTE-M support for NTN.

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite.
Access link, also known as service link, that refers to the link between a satellite and a user equipment (UE).

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

The significant orbit height means that satellite systems are characterized by a path loss that is significantly higher than what is expected in terrestrial networks. To overcome the pathloss, it is often required that the access and feeder links are operated in line of sight conditions, and that the UE is equipped with an antenna offering high beam directivity.

A communication satellite typically generates several beams over a given area. The footprint of a beam is usually in an elliptic shape, which has been traditionally considered as a cell (although a cell consisting of the footprint of multiple beams has not been ruled out in 3GPP). The footprint of a beam is also often referred to as a spotbeam. The spotbeam may move over the earth surface with the satellite movement (the so-called moving beams/cells case/architecture) or may be earth fixed (the so-called earth fixed beams/cells case/architecture) with some beam pointing mechanism used by the satellite to compensate for its motion. The footprint size of a spotbeam depends on the system design, which may range from tens of kilometers to a few thousands of kilometers.

In comparison to the beams observed in a terrestrial network, a NTN beam may be very wide and cover an area outside of the area defined by the served cell. A beam that covers adjacent cells will overlap with another beam and cause significant levels of intercell interference. To overcome the large levels of interference, a typical approach is to configure different cells with different carrier frequencies and polarization modes.

As used herein, the terms beam and cell are often used interchangeably, but not in all cases.

3GPP has considered two basic architectures for NTN:
Transparent payload architecture (also referred to as bent pipe architecture). In this architecture the gNodeB (gNB) is located on the ground and the satellite forwards signals/data between the gNB and the UE.
Regenerative payload architecture. In this architecture the gNB is located in the satellite.

In the work item for NR NTN in 3GPP Release 17, only the transparent payload architecture is considered.

FIG. 1 illustrates an example architecture of a satellite network with bent pipe transponders (i.e. the transparent payload architecture). The gNB may be integrated in the gateway or connected to the gateway via a terrestrial connection such as, for example, a wire, optic fiber, or wireless link.

Propagation delay is an important aspect of satellite communications that is different from the delay expected in a terrestrial mobile system. For a bent pipe satellite network, the round-trip delay may, due to the orbit height, range from tens of ms in the case of LEO to several hundreds of ms for GEO. This can be compared to the round-trip delays catered for in a cellular network which are limited to 1 ms.

The propagation delay may also be highly variable due to the high velocity of the LEO and MEO satellites and change in the order of 10-100 us every second, depending on the orbit altitude and satellite velocity.

In 3GPP TR 38.821, it has been captured that ephemeris data should be provided to the UE to assist, for example, with pointing a directional antenna (or an antenna beam) towards the satellite and to calculate a correct Timing Advance (TA) and Doppler shift. Procedures on how to provide and update ephemeris data have not yet been studied in detail.

A satellite orbit can be fully described using 6 parameters. Exactly which set of parameters is chosen can be decided by the user; many different representations are possible. For example, a choice of parameters used often in astronomy is the set (a, ε, i, Ω, ω, and t). FIG. 2 illustrates the example set of parameters. Here, the semi-major axis a and the eccentricity ε describe the shape and size of the orbit ellipse; the inclination i, the right ascension of the ascending node Ω, and the argument of periapsis ω determine its position in space, and the epoch t determines a reference time such as, for example, the time when the satellites moves through periapsis.

As an example of a different parametrization, the Two-Line Element (TLE) (which may also be referred to as Two-Line-Elements and Two-Line Element set) uses mean motion n and mean anomaly M instead of a and t. A completely different set of parameters is the position and velocity vector (x, y, z, vₓ, v_{y}, v_{z}) of a satellite. These are sometimes called orbital state vectors. They can be derived from the orbital elements and vice versa since the information they contain is equivalent. All these formulations (and many others) are possible choices for the format of ephemeris data to be used in NTN. To enable further progress, the format of the data should be agreed upon.

The above discussion has shown that it is important that a UE can determine the position of a satellite with accuracy of at least a few meters. However, several studies have shown that this might be hard to achieve when using the de-facto standard of TLEs. On the other hand, LEO satellites often have Global Navigation Satellite System (GNSS) receivers and can determine their position with some meter level accuracy.

Another aspect discussed during the study item and captured in 3GPP TR 38.821 is the validity time of ephemeris data. In general, predictions of satellite positions degrade with increasing age of the ephemeris data used due to atmospheric drag, maneuvering of the satellite, imperfections in the orbital models used, etc. Therefore, the publicly available TLE data are updated quite frequently, for example. The update frequency depends on the satellite and its orbit and ranges from weekly to multiple times a day for satellites on very low orbits which are exposed to strong atmospheric drag and need to perform correctional maneuvers often.

So, while it seems possible to provide the satellite position with the required accuracy, care needs to be taken to meet these requirements such as, for example, when choosing the ephemeris data format or the orbital model to be used for the orbital propagation.

3GPP TS 23.032 “Geographical Area Description (GAD)” provides geographical area descriptions which can be converted into an equivalent radio coverage map. The shape definitions use the World Geodetic System 1984 (WGS 84) ellipsoid as a reference. For example, a point and radius are defined as follows:

### Point:

The co-ordinates of an ellipsoid point are coded with an uncertainty of less than 3 metres.
The latitude is coded with 24 bits: 1 bit of sign and a number between 0 and 2²³−1 coded in binary on 23 bits. The relation between the coded number N and the range of (absolute) latitudes X it encodes is the following (X in degrees):

$$N \leq \frac{{2}^{23}}{90} X < N + 1$$

except for N=2²³−1, for which the range is extended to include N+1.
The longitude, expressed in the range −180°, +180°, is coded as a number between −2²³ and 2²³−1, coded in 2's complement binary on 24 bits. The relation between the coded number N and the range of longitude X it encodes is the following (X in degrees):

$$N \leq \frac{{2}^{24}}{360} X < N + 1$$

### Radius:

Inner radius is encoded in increments of 5 meters using a 16 bit binary coded number N. The relation between the number N and the range of radius r (in metres) it encodes is described by the following equation:

$$5 N \leq r < 5 ( N + 1 )$$

Except for N=2¹⁶−1 for which the range is extended to include all greater values of r. This provides a true maximum radius of 327,675 meters.
The uncertainty radius is encoded as for the uncertainty latitude and longitude.

There currently exist certain challenge(s). For example, as described above, ephemeris data consists of at least 5 parameters describing the shape and position in space of the satellite orbit. It also comes with a timestamp, which is the time when the other parameters describing the orbit ellipse were obtained. The position of the satellite at any given time in the nearer future can be predicted from this data using orbital mechanics. The accuracy of this prediction will degrade, however, as one projects further and further into the future. The validity time of a certain set of parameters depends on many factors like the type and altitude of the orbit but also on the desired accuracy. The validity time may range from the scale of a few days to a few years.

In Release 17, 3GPP is expected to adapt NR and possibly LTE for operation in an NTN. In NR and LTE, when turned on, a UE is expected to perform an initial search over its supported frequency bands for a PLMN and a cell to camp on.

In an NTN, and in worst case, a UE uses a directional antenna to search for a satellite to camp on over the entire sky from horizon to horizon. A similar problem arises when the UE should search for cells transmitted from another satellite such as, for example, in preparation for a handover or a potential cell reselection. This effort and, thus, the time required for the initial search, can be reduced significantly by providing the UE with ephemeris data, which informs the UE about the location of the satellites and, thus, where it has to point its antenna.

However, even if the UE points its antenna in a proper direction to receive DL transmissions from a satellite, this is of no use if the satellite does not cover the UE's location with its DL transmissions. This may potentially result in suboptimal UE operation and in turn suboptimal system performance.

### SUMMARY

Certain aspects of the present disclosure and their embodiments may provide solutions to these or other challenges. For example, to address the problem(s) described above, certain embodiments are disclosed for providing the UE or base station with information enabling it to determine a cell's coverage area at any given time within the validity time of satellite ephemeris data.

According to certain embodiments, a method by a wireless device for determining cell coverage area provided by one or more satellites includes receiving information at the wireless device. The wireless device uses the received information to obtain a location of the cell coverage area provided by the one or more satellites for a plurality of times.

According to certain embodiments, a wireless device is provided for determining cell coverage area provided by one or more satellites. The wireless device is adapted to receive information at the wireless device and use the received information to obtain a location of the cell coverage area provided by the one or more satellites for a plurality of times.

According to certain embodiments, a method by a base station for providing information for determining cell coverage area provided by one or more satellites includes transmitting, to the wireless device, information comprising a parameter other than ephemeris data. The parameter is associated with a cell coverage area provided by the one or more satellites for a plurality of times.

According to certain embodiments, a base station is for providing information for determining cell coverage area provided by one or more satellites. The base station is adapted to transmit, to the wireless device, information comprising a parameter other than ephemeris data. The parameter is associated with a cell coverage area provided by the one or more satellites for a plurality of times.

Certain embodiments may provide one or more of the following technical advantages. For example, a technical advantage of certain embodiments may be that a prediction can be made of whether a UE is, or will be, in the coverage area of a certain cell. Such a prediction may be for a current moment or for any point in the not too distant future at least within the validity time of the ephemeris and cell coverage data. This can improve the UE's operation and performance while searching for cells or determining which of two or more seemingly more or less equivalent cells to connect or camp in. Where this determination is made by the UE, the determination may be based on the received signal strength of the cells. As such certain embodiments may also facilitate and improve the UE's operation in conjunction with conditional mobility procedures in RRC_CONNECTED state such as, for example, if the cell coverage information is used as input to a decision whether or not to execute a conditional handover, PSCell addition, PSCell change or SCell additions.

As another example, a technical advantage may be that the base station is able to perform and/or otherwise facilitate the prediction of whether a UE is, or will be, in the coverage area of a certain cell. For example, the base station may obtain the UE's location, either by requesting (or otherwise receiving) the UE to provide its location (e.g. based on GNSS measurements) or by determining the UE's positioning using a network based or network assisted method, such as various forms of time of arrival difference measurements (where the same signal is transmitted from different sources towards the UE or a signal transmitted by the UE is received by different receivers). The base station may convey the result of the prediction to the UE, in full or only in parts. Accordingly, a technical advantage may be that certain embodiments enable the base station to use the prediction result to improve the operation in relation to the UE such as, for example, in terms of selection of neighbor cells for cell quality measurement (e.g. for handover assessment) or for selection of potential target cells for handover.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network with bent pipe transponders;

FIG. 2 illustrates the example set of parameters;

FIG. 3 illustrates examples of cell areas calculated according to the independent cell principle, according to certain embodiments;

FIG. 4 examples of cell areas calculated according to the independent cell principle, according to certain embodiments;

FIG. 5 illustrates examples of actual cell areas calculated according to the coexisting cell principle, according to certain embodiments;

FIG. 6 illustrates an example method of a UE's operation, according with embodiments;

FIG. 7 illustrates an example wireless network, according to certain embodiments;

FIG. 8 illustrates an example network node, according to certain embodiments;

FIG. 9 illustrates an example wireless device, according to certain embodiments;

FIG. 10 illustrate an example user equipment, according to certain embodiments;

FIG. 11 illustrates a virtualization environment in which functions implemented by some embodiments may be virtualized, according to certain embodiments;

FIG. 12 illustrates a telecommunication network connected via an intermediate network to a host computer, according to certain embodiments;

FIG. 13 illustrates a generalized block diagram of a host computer communicating via a base station with a user equipment over a partially wireless connection, according to certain embodiments;

FIG. 14 illustrates a method implemented in a communication system, according to one embodiment;

FIG. 15 illustrates another method implemented in a communication system, according to one embodiment;

FIG. 16 illustrates another method implemented in a communication system, according to one embodiment;

FIG. 17 illustrates another method implemented in a communication system, according to one embodiment;

FIG. 18 illustrates an example method by a wireless device, according to certain embodiments; and

FIG. 19 illustrates an example method by a network node, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the terms “cell area”, “cell coverage area”, “cell area shape”, “cell coverage area shape” and sometimes also “cell coverage” may be used as equivalent terms.

Additionally, the terms “beam” and “satellite beam” may be seen as equivalent.

Furthermore, the concept of a satellite serving a cell means that the satellite is responsible for transmitting and receiving signals and data to/from UEs in the cell. In the transparent payload architecture, this also means that the satellite forwards signals and data (in both directions) between the gNB controlling the cell and the UEs in the cell. Consequently, a cell's serving satellite is the satellite serving the cell. Similarly, a UE's serving satellite is the satellite serving the UE's serving cell, i.e. the cell that the UE is camping on (in RRC_IDLE or RRC_INACTIVE state) or is connected in (in RRC_CONNECTED state). Correspondingly, a satellite is serving a UE if the UE is camping on (in RRC_IDLE or RRC_INACTIVE state) or is connected in (in RRC_CONNECTED state) a cell served by the satellite.

Moreover, the term “neighbor satellite” should in the context of this document be understood as a satellite serving a neighbor cell. Depending on the context, a neighbor cell may be (from the UE's perspective) a cell neighboring a serving cell of the UE, or (from a first satellite's perspective or the perspective of a gNB using a first satellite) a neighbor cell may be a cell served by a second satellite which neighbors at least one of the cells served by the first satellite. In line with this, from a satellite/gNB perspective, two satellites are neighbors if at least one of the cell(s) served by one of the satellites neighbors to at least one of the cell(s) served by the other satellite.

The cell area descriptions provided herein may also be applied to beam coverage areas (which often are equivalent).

The solution embodiments are mainly described in terms of NTNs using NR technology, but they may also be applied to NTNs using other RATs, such as LTE.

The solution embodiments focus on provision of cell coverage information in NTNs, where the cell coverage information pertains to NTN cell(s). However, the solution is also applicable in embodiments where a UE obtains the cell coverage information from a node in a Terrestrial Network such as, for example, a gNB controlling an NR cell (or an eNB controlling an LTE cell) that is the UE's serving cell. Similarly, although certain embodiments focus on cell coverage information pertaining to NTN cell(s), this does not exclude that cell coverage information may pertain to cell(s) in Terrestrial Network(s). In the most general case, cell coverage information may be provided to a UE by either a NTN node or a Terrestrial Network node and the provided cell coverage information may pertain to NTN cell(s) or Terrestrial Network cell(s) or may pertain to both NTN cell(s) and Terrestrial Network cell(s).

To address certain problems described above, certain embodiments disclosed herein provide the UE with information enabling it to determine a cell's coverage area at any given time (within the validity time of satellite ephemeris data). To this end, information describing a cell's coverage area is associated with the ephemeris data of the satellite responsible for serving the cell. Furthermore, the cell coverage information may contain information, or be related to a formula, which allows the UE to determine changes of the cell's coverage area over time.

In a particular embodiment, the cell coverage information may contain area shape description(s) and time dependence information. For example, the UE may be provided with information about how a cell's coverage area changes over time. Accordingly, in a particular embodiment, the cell coverage information may be repeatedly updated (on a periodic or non-periodic basis) to reflect changes in the cell's coverage area. The solutions consist primarily of methods for providing cell coverage data combined with satellite ephemeris data in efficient ways.

If satellite ephemeris data and cell coverage information is provided to a UE in another cell than the cell coverage information concerns, additional parameters may be provided to further facilitate the UE's interaction with the network, e.g. one or more cell identifiers of the cell the cell coverage information concerns, e.g. the PCI and/or the NCGI, an identifier of the PLMN the concerned cell belongs to, e.g. a PLMN ID, one or more identifier(s) of the tracking area(s) the concerned cell belongs to, e.g. one or more TAI(s) or TAC(s), and/or an identifier of the satellite responsible for serving the cell (i.e. transmitting and receiving (and forwarding) signals and data in the cell). Cell information concerning other cells then the ones belonging to the same gNB may be obtained through inter-node signaling in the network or possibly or partly via configuration, e.g. from an O&M system.

In various particular embodiments, a UE or base station can use such obtained cell coverage information of one or more cells to improve the efficiency of the UE's operation in various autonomous or partly autonomous procedures. Such procedures may include, for example, cell search, cell (re) selection assessments and decisions, tracking area update decisions and/or mobility decisions in RRC_CONNECTED state. For example, the cell coverage information may be used as input for performing a decision as to whether or not to execute a conditional mobility procedure such as, for example, a conditional handover, a conditional PSCell addition, a conditional PSCell change or a conditional SCell addition.

According to certain embodiments, two different principles can be used. These may be denoted as the independent cell principle and the coexisting cell principle, and are described in more detail below.

### Independent Cell Principle

According to the independent cell principle, a UE is provided with information describing an area on the earth's surface in which the DL transmissions (e.g. common signaling such as SSBs, SI, common reference signals) intended for the cell may be detected with a certain minimum signal strength (e.g. measured in Watts or dBm and calculated e.g. as RSRP), assuming a certain theoretical reference receiver with certain reference properties, including e.g. antenna gain. The area description does not take into account the presence of any other cells, which in practice affects where the cell's borders are.

As the distance from the cell center increases, the received signal strength decreases. The received signal strength of a possible neighboring cell may increase in a corresponding way. Typically, the cell border is said to be at a line where the received signal strengths are equal in the two neighboring cells. With the independent cell principle, it is left to the UE to determine where the border between two cells lies. For example, the UE may use the equal received signal strength principle to determine where the border is between two cells. In this determination, the UE can use independent cell area descriptions of two cells that overlap each other together with estimations of how the received signal strength would change when moving from the coverage area border towards the center of the coverage area for the respective cell areas (e.g. determining a received signal strength gradient). In such an estimation, the UE may utilize the distance and elevation angle to the concerned satellite obtained from satellite ephemeris data (to determine power dilution due to distance as well as attenuation caused by the earth's atmosphere), possibly together with information about the DL transmission power used for the concerned DL signals in the concerned cell(s) (which may be signaled from the base stations/satellites).

The received signal strength of a cell may be great enough even where the received signal strength of another cell is greater at the same position. Thus, a UE may remain in (or (re) select or be handed over to) a cell which does not provide the greatest signal strength at the UE's location for camping or communication. This may be done to achieve other advantages such as, for example, a longer time to be served in the cell (depending on cell movements or cell switches) or for better load balancing between the cells. Other circumstances may also impact the choice of cell or the perceived signal strength, such as temporary presence of blocking or reflecting objects, precipitation, clouds, etc. For these reasons, a cell border is inherently “fuzzy”.

A cell coverage area, in particular one covered by a single satellite beam, calculated according to the independent cell principle, can typically be approximated with an ellipse where the eccentricity of the ellipse depends on the satellite's elevation angle. The smaller the elevation angle, the greater the eccentricity in the resulting ellipse. In the nadir direction, the cell area would typically be circular, assuming a beam cone with rotational symmetry.

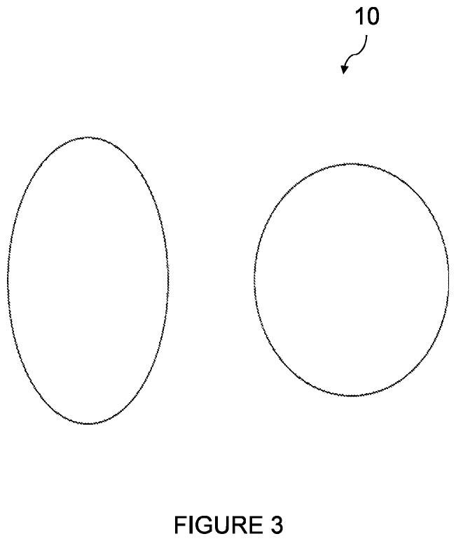

FIG. 3 illustrates examples of cell areas 10 calculated according to the independent cell principle, according to certain embodiments. Specifically, FIG. 3 illustrates an elliptical cell area on the left and a circular cell area on the right.

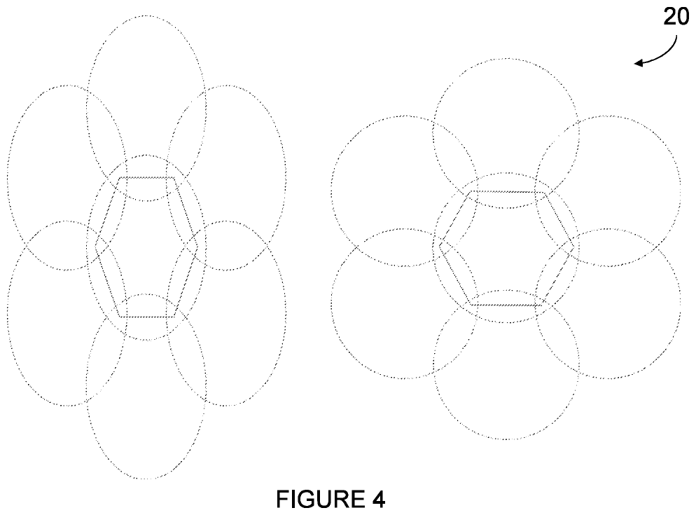

FIG. 4 illustrates examples of actual cell areas 20 (shown in solid lines derived from cell areas (with dashed lines) calculated according to the independent cell principle, according to certain embodiments. Specifically, FIG. 4 illustrates a hexagon inscribed in an ellipse on the left and a hexagon inscribed in a circle on the right.

A cell area calculated or estimated (or measured) according to the independent cell principle can be referred to as the cell's independent coverage area or the cell's non-interfered coverage area.

### Coexisting Cell Principle

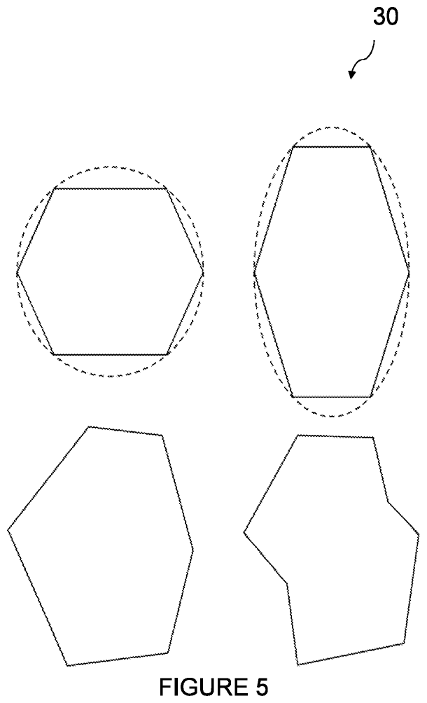

With the coexisting cell principle, the cell coverage information provided to the UE would inherently take the presence and impact of neighboring cells into account. For instance, in line with the above example, the indicated cell coverage area would not simply indicate an area in which the relevant DL signals can be expected to be received with at least a certain minimum/threshold signal strength, but would also take into account whether the corresponding DL signals transmitted in a neighbor cell could be expected to be received with greater signal strength. As a result of this consideration, the border of an indicated cell coverage area would enclose an area in which the relevant DL signals in the cell can be expected to be received with at least a minimum signal strength and be received with a signal strength that is greater than or equal to the signal strength of the corresponding DL signals of any other (neighboring) cells. FIG. 5 illustrates examples of actual cell areas 30 calculated according to the coexisting cell principle, according to certain embodiments.

In a slightly idealized and simplified scenario, where all cells have the same shape and size and the resulting cell density is homogeneous (i.e. the distance between the centers of two cells neighboring each other is the same in a concerned area, e.g. around a concerned cell), a cell area calculated according to the independent cell principle is a hexagon that is symmetric with respect to a center line and may be inscribed in an ellipse (or, in the nadir direction, a hexagon with rotational symmetry which may be inscribed in a circle). Accordingly, from the left in the upper row, FIG. 5 illustrates cell areas in the form of a hexagon inscribed in a circle and a hexagon inscribed in an ellipse.

When the cells' relative shapes and sizes deviate from this idealized scenario, a cell coverage area calculated according to the independent cell principle is (at least approximately) a polygon (which still can be a hexagon, unless other aspects than neighboring cells significantly impact the coverage of relevant downlink signals). From the left in the lower row, FIG. 5 illustrates cell areas in the form of a polygon forming an asymmetric hexagon and a polygon with inner angles below and above 180 degrees.

In the earth fixed beams/cells case, deviations from the idealized scenario may e.g. be caused by differing elevation angles of the satellites serving two neighboring cells. In the moving beams/cells scenario, deviations from the idealized scenario may be caused by the movements of the satellites and cells, which continuously shift the cells' locations relative each other, causing a situation matching the idealized scenario to immediately change into a non-idealized scenario. Thus, the dynamic nature of the moving beams/cells scenario inherently prevents the idealized scenario from being permanent.

In addition, in both the earth fixed beams/cells and the moving beams/cells scenarios, deviations from the idealized scenario may be caused by inhomogeneous satellite density. For instance, at any given time, a deployment with polar satellite orbits will be denser among the satellites in the polar regions than in regions closer to the equator. Hence, the distance to a neighbor satellite will typically be longer in the direction towards the equator than away from the equator (which in particular in the moving beams/cells scenario is directly reflected in the cell density and distances between neighboring cell's center points).

### Earth Fixed Beams/Cells

In the case of earth fixed beams/cells, certain embodiments provide a UE with cell coverage information (preferably associated with satellite ephemeris data). Such information may include, in a particular embodiment, a shape description of a cell covering a certain geographical area together with information of how this shape will change over time. The time related information, i.e. the information about time dependence, may include a schedule for when the responsibility for serving the concerned cell area (i.e. serving the cell covering the area) switches from one satellite to another. Together with other relevant parameters, e.g. including the PCI and/or other parameters as described above can be considered the basic cell coverage information. Note that 3GPP has not yet decided which parameters, e.g. identifiers like the PCI, NCGI, TAI and TAC, that will be kept unchanged across a satellite switch and which that will change. If a parameter that is included in the above described information such as, for example, the PCI, is changed in conjunction with a satellite switch, the change should be visible in the satellite switch schedule such that the UE knows which PCI will be broadcast in the cell area before and after each satellite switch included in the schedule.

The above described basic cell coverage information is a good baseline. However, in the earth fixed beams/cells case, the shape of the cell will not remain constant over time. This is due to the fact that the serving satellite moves in relation to the cell's location on the surface of the earth. Thus, unless the satellite strives to maintain a constant cell shape by adapting the beam cones, the beam/cell coverage area will be elongated, or stretched, along the line that represents the horizontal projection of the line between the cell center and the satellite, when the satellite's elevation angle (in relation to the cell) is small compared to when the elevation angle is large. If the cell center is right below the satellite's orbit, the elongation will be along the satellite's orbit's projection on the earth's surface. For instance, with the independent cell principle for the cell coverage, the cell coverage area would start as an ellipse when the elevation angle to the satellite is low, then the cell coverage area would gradually change into a circle (assuming 90 degrees elevation angle as the maximum) to gradually go back to being an ellipse when the satellite's elevation angle decreases again as the satellite approaches the horizon (wherein the eccentricity of the ellipse increases with decreasing elevation angle). Similarly, with the coexisting cell principle for cell coverage (and the slightly simplified assumption that a cell area becomes a symmetric hexagon with this principle), the cell coverage area may go from an elongated/stretched hexagon (inscribed in an ellipse) to a regular hexagon (i.e. a hexagon with rotational symmetry—i.e. inscribed in a circle—and inner angles of 120 degrees each) and then back to an elongated/stretched hexagon again as the satellite's elevation angle changes from small to large and back go small again.

According to certain embodiments, the time dependence of the cell coverage area shape may be explicitly or implicitly indicated to the UE. Explicit time dependence information could consist of a series of area shape descriptions, each associated with a time stamp or a time increment, and the UE could use interpolation to derive the shapes in between the time stamps, in a particular embodiment. Possibly, such multiple shape descriptions could consist of a one complete shape description while the other shape descriptions would be represented as indicated differences (deltas) from the complete shape description.

Another form of explicit time dependence information could be a mathematical formula which takes the time as input and produces the shape description as output. A variation of this approach could be to provide a complete shape description then one or more mathematical formula, e.g. where each of one or more the mathematical formula would be a function of time, producing one or more shape property/properties as output (wherein a shape property may be e.g. a circle radius, the semi-major axis or semi-minor axis of an ellipse, the eccentricity of an ellipse or a scaling factor to be applied to all or a subset of all linear measures of the complete shape descriptions. As one option for the coexisting cell case, the UE could first calculate the ellipse (or circle) representing the non-interfered cell area and then calculate the actual cell area as a hexagon inscribed in the ellipse (or circle), in a particular embodiment.

According to certain embodiments, implicit time dependence information may consist of information that enables a UE to autonomously determine how the cell coverage area will change as a function of time. To perform such calculations, the UE needs to know the ephemeris data of the concerned cell's serving satellite as well as information related to the beam(s) the satellite uses to cover the cell with DL transmissions. The satellite ephemeris data is normally provided to the UE for other purposes, but if provision of cell coverage area information is relevant in a context where the UE is not otherwise provided with the ephemeris data of the concerned satellite, then provision of the satellite's ephemeris data may be introduced for the purpose of supporting cell coverage area information provisioning in accordance with certain embodiments described herein. As for the information related to the beam(s) that the satellite uses to cover the cell with DL transmissions, this information may have the form of the cell coverage area such as, for example, represented by the footprint (in terms of shape and size (and location if needed)) of the beam(s) at a given reference elevation angle (or at a given point in time which may be translated into elevation angle if the cell location is given). This reference footprint is equivalent to the cell coverage area with the reference satellite elevation angle when the independent cell principle is used (i.e. the cell's non-interfered coverage area). Using this information together with the change of satellite elevation angle over time (which can be derived from the satellite ephemeris data) allows the UE to calculate how the shape of the cell coverage area changes as a function of the satellite elevation angle, where the satellite elevation angle in turn is a function of time (which means that the cell coverage area shape also can be calculated as a function of time). In essence, the satellite's elevation angle's deviation from the reference elevation angle lets the UE calculate how the cell coverage area shape deviates from the reference footprint. As one option, the reference elevation angle may be 90 degrees.

An alternative form of beam related information may be the solid angle of the beam (or bundle of beams) used to cover the cell area, together with the direction of the beam(s) at a given point in time. Assuming that the satellite uses a fixed solid angle for its beam(s), this information allows the UE to calculate the footprint of the beam(s) as a function of the satellite's elevation angle and altitude, where the satellite's elevation angle and altitude can be derived as a function of time based on the satellite's ephemeris data.

Similar to what was discussed above, also in the case where the UE autonomously calculates the time dependent change of the cell area (based on information obtained from the network), one option for the coexisting cell case may be that the UE first calculates the ellipse (or circle) representing the non-interfered cell area and then calculates the actual cell area as a hexagon inscribed in the ellipse (or circle), according to certain embodiments.

In particular embodiments, the time related information may consist of at least any combination of the following:
One or more cell area descriptions with associated time stamps.
One or more mathematical formula describing the cell area or different parameters related to the cell area's properties as function(s) of time.
A reference cell area, e.g. in the form of a satellite beam footprint (or satellite beam bundle footprint), which may be associated with a certain satellite elevation angle.
A reference satellite elevation angle (which may be associated with a reference cell area or a reference satellite beam footprint).
A cell location represented by a center location of the cell's coverage area.
A solid angle of a satellite beam, whose footprint represents the non-interfered cell area.
A solid angle of a bundle of satellite beams whose combined footprint represents the non-interfered cell area.
A solid angle of each satellite beam in a bundle of beams whose combined footprint represents the non-interfered cell area.
A direction of a satellite beam, whose footprint represents the non-interfered cell area.
A direction of a bundle of satellite beams whose combined footprint represents the non-interfered cell area.
A direction of each satellite beam in a bundle of beams whose combined footprint represents the non-interfered cell area.
Satellite ephemeris data.

It should be pointed out that the information about the time dependence of the cell coverage area may span time periods across satellite switches (which also may include cell switches). And, in general, the time dependent continuous shape alteration of the cell coverage area will have discontinuous “jumps” at every satellite switch, mainly depending on the change in elevation angle between the old and the new satellite (but potentially also depending on minor differences in transmission properties between the old and the new satellite, e.g. in terms of beam direction accuracy, beam directivity and/or solid angle of a beam). Effectively, a continuous mathematical function describing the cell coverage area as a function of time may be provided which is valid in the time periods between satellite switches, e.g. defined for T₀<t<T₁, T₁<t<T₂, . . . . T_{N-1}<t<T_{N}, where satellite switches occur at times T₀, T₁, T₂, . . . . T_{N}, These time intervals may typically be of equal (or almost equal) lengths, reflecting that satellite switches typically occur periodically with a regular periodicity.

According to certain embodiments, the information that is described above as being provided to the UE may also or alternatively be provided to the base station. Appropriate calculations can be made by either the UE, the base station, or both, if needed. In some embodiments, when the information is provided to the base station, the base station may in turn provide the information, fully or in parts, to the UE or it may provide information to the UE which results from processing of the received information, e.g. results of the above mentioned appropriate calculations, and/or it may use the received information to improve the operation in relation to the UE.

### Moving Beams/Cells

A moving cell is a cell that follows the footprint of a beam (or possibly multiple beams) of a certain satellite as the satellite travels along its orbit. Furthermore, the satellite is assumed to have a fixed beam direction in relation to the nadir direction, or in relation to the ground, such that the cell's beam(s) maintain(s) a fixed angle in relation to the earth's surface (e.g. in relation to the WGS 84 ellipsoid surface). As the cell moves with the satellite, this means that its characterizing identifiers should stay the same as the cell moves. However, 3GPP has not made its mind up about how identifiers like the PCI and the NCGI will be handled for moving cells. As one option, these identifiers may stay the same in a moving cell for the satellite's entire orbit (lap after lap). As another option, the NCGI may be associated with a certain geographical area, meaning that the NCGI will change when the satellite's beam footprint moves from one such geographical area to another, and during the transition period, both the old and the new NCGI may be broadcast in the moving cell. As yet another option, the NCGI (and possibly the PCI too) would change when the gNB controlling the satellite serving the moving cell changes, e.g. at feeder link switches. Whatever solution that 3GPP eventually agrees on, the identifier(s) that are relevant may be seen as part of, or accompanying, the cell describing information or cell area describing information.

As for the cell area shape, this could be described and signaled in the form of shape describing parameters together with a time dependence formula describing how the cell moves with time, according to certain embodiments. If the concerned beam (or beam bundle) is pointed in the nadir direction, the resulting footprint constituting the non-interfered cell area should ideally become a circle. This can be described by a center position and a radius (or a diameter). The time dependence could be described in terms of a velocity, including speed and direction, with which the center point and the entire circle moves. However, this would only represent a snapshot of the time dependence and a full time dependence description requires an expression of the satellite's projection on the ground as a function of time, as the satellite travels along its orbit.

If the beam (or bundle of beams) whose footprint constitute the non-interfered cell area is not pointing in the nadir direction (e.g. if the serving satellite serves two cells bordering to each other in the nadir direction), then the cell area may be approximated with an ellipse rather than a circle (see also chapter 0). Otherwise, the above description still applies.

Another, possibly more preferable, way to convey the cell area information (including size, shape and time dependence) to the UE may be to use a combination of the satellite's ephemeris data and information about the beam (or beam bundle) whose footprint constitutes the non-interfered cell area. As for the beam (or beam bundle), assuming that the satellite keeps it fixed in relation to its nadir direction, it would be sufficiently described by its solid angle and its direction/angle in relation to the nadir direction or in relation to the earth's surface.

If this information is conveyed to the UE, the UE could use it to calculate the cell's non-interfered coverage area at any point in time. The UE could for instance first calculate the satellite's position at the concerned point in time using the ephemeris data, and then, using the beam information, the UE could calculate the beam footprint relative the satellite and hence on the ground, in a particular embodiment. With knowledge also of neighbor cells' non-interfered cell areas, the UE could estimate the respective cell's signal strength at different locations and from this derive the actual cell border (or could at any current or future point in time determine which cell the UE's current location belongs to, i.e. which cell/beam/satellite that has the greatest signal strength at the UE's location, in a particular embodiment.

In another embodiment, an alternative way would be that the network provides a description of the moving cell's non-interfered coverage area (including shape, size and location) at a given time (e.g. referred to as reference area and reference time) together with the serving satellite's ephemeris data. The ephemeris data allows the UE to determine the serving satellite's position at the given point in time and from that the relation between the satellite position and the location on the ground of the cell's non-interfered coverage area. If the eccentricity of the satellite's orbit is negligible, the UE can then assume that the shape and size will remain the same as the moving cell's location (e.g. defined as a circle center point or a focal point of an ellipse) follows the movements of the satellite. If the eccentricity of the serving satellite's orbit is non-negligible (i.e. the difference between the satellite's minimum and maximum altitudes during a lap around the orbit is non-negligible), the properties of the moving cell's non-interfered coverage area depends on how the satellite manages its beam(s).

If the satellite maintains fixed beam properties (in terms of direction relative to the nadir direction or relative to the ground, solid angle and transmission power), the size of the cell's non-interfered coverage area will vary with the satellite's altitude. To be able to predict these variations, the UE can use the provided reference area and reference time together with the satellite's position at the reference time (which can be calculated from the ephemeris data) to calculate the fixed beam properties. Once the fixed beam properties are known, the UE can calculate the resulting beam foot print (and thus the cell's non-interfered coverage area) as a function of the satellite's altitude (and position), where this altitude at any point in time can be calculated from the satellite's ephemeris data. Such a slightly “pulsating” non-interfered cell area may also cause the actual cell borders to move back and forth, depending on the eccentricities of the respective orbits of the satellites serving the two cells neighboring each other.

However, if the satellite operates with an active beam management in the sense that it strives to maintain a fixed shape and size of the moving cell's non-interfered coverage area by changing the beam properties (e.g. varying the solid angle and/or the transmission power), then the UE can assume that the shape and size of the moving cell's non-interfered coverage area remains constant as it moves with the satellite, similar to the case of a satellite with an orbit with negligible eccentricity.

As another alternative, in a particular embodiment, the network may provide the UE with the actual cell area (i.e. taking the impact of neighboring cells into account). The network would combine its knowledge of the beam footprints of the satellites at any given time and compute the resulting cell area, which could have the form of a polygon (ideally a hexagon), whose shape, size and time dependence would be conveyed to the UE. A polygon may be described e.g. by the positions of its corners. As the time dependence may be rather complex, the network may quite frequently update the cell area information conveyed to the UE(s).

As yet another alternative, in a particular embodiment, the UE may be provided with inter-satellite distances of the relevant satellites such as, for example, the UE's serving satellite and its neighbor satellites. If the beam directions relative to the ground of all the satellites are equivalent, this allows the UE to estimate where the borders between the satellites' served cells are located. Such inter-satellite distances could be conveyed explicitly to the UE (with or without time dependence information), but could alternatively be inferred from the ephemeris data of the concerned satellites. If the UE is provided with all the concerned satellites' respective ephemeris data, the UE could itself calculate the satellites' positions at any given time and from this also estimate the borders between the cells of neighboring satellites.

Information described above as being provided to the UE may also be provided to the base station, instead of or in addition to the UE, and appropriate calculations can be made by either the UE, base station, or both, if needed. In some embodiments, when the information is provided to the base station, the base station may in turn provide the information, fully or in parts, to the UE or it may provide information to the UE which results from processing of the received information, e.g. results of the above mentioned appropriate calculations, and/or it may use the received information to improve the operation in relation to the UE.

### Cell Area Descriptions

In general, a cell area may be explicitly described in terms of a shape, including its size, together with a location and an orientation. For the location and orientation of the area, a coordinate system is needed. Implicit representations in the form of beam descriptions combined with the serving satellite's ephemeris data also serves the purpose, as it allows a UE to calculate the resulting cell are on the earth's surface.

In particular embodiments, when an explicit cell area description is used, a suitable coordinate system may be an earth fixed coordinate system with origin at the center of the earth or, may be more preferable, at the center point of the WGS 84 ellipsoid, the Z axis pointing north and the X and Y axis pointing at defined longitudes (e.g. with the X axis pointing at longitude 0° and the Y axis pointing at 90° east).

Directions on the surface of the earth (horizontal directions) may also be described as angles relative to the longitudes (e.g. the relative to the north direction) or latitudes (e.g. relative to the east direction).

In particular embodiments relying upon implicit cell area descriptions, e.g. leveraging satellite ephemeris data and beam property descriptions, it may be beneficial to use a coordinate system following the satellite (i.e. with the origin of the coordinate system at the satellite) with a Z axis that always traverses the center of the earth (preferably represented by the center point of the WGS 84 ellipsoid), i.e. the Z axis either always points in the direction towards the center of the earth or always points away from the center of the earth. Such a coordinate system may be particularly useful in the moving beams/cells case, but may also be used in the earth fixed beams/cells case.

If coordinate systems are chosen such that each satellite has its own coordinate system, it may be useful to have a common reference coordinate system in terms of which the orientation of each satellite's own coordinate system may be described. This will allow transformation/translation of coordinates in any of the satellites' coordinate systems into coordinates in the common reference coordinates system and vice versa. A possible choice of common reference coordinate system may be an earth fixed coordinate system, e.g. of the type described above, i.e. with the origin at the center of the WGS 84 ellipsoid, the Z axis pointing north and the X and Y axis pointing at defined longitudes (e.g. with the X axis pointing at longitude 0° and the Y axis pointing at 90° east). Other coordinate systems may also be used, e.g. any coordinates system used for expression of satellite ephemeris data.

There are also different possible choices of coordinates to use when expressing locations and directions in a coordinate system. Notably, two attractive alternatives may be cartesian coordinates and spherical coordinates, where the latter e.g. allows easy expression of a beam's direction and solid angle in a coordinate system centered at the satellite.

There are numerous combinations of parameters which may be used to fully describe an ellipse, which is a suitable for a cell area based on the independent cell principle (i.e. a cell's non-interfered coverage area).

As one example, the following ellipse related parameters may be used:
Semi-minor axis.
Semi-major axis.
Directional angle, e.g. in relation to north. (This may also be implicit, e.g. if it is assumed to be parallel with the satellite orbit's projection on the earth's surface, e.g. if the satellite's orbit passes over the cell center.)

Another example:
Semi-minor axis.
Eccentricity.
Directional angle, e.g. in relation to north. (This may also be implicit, e.g. if it is assumed to be parallel with the satellite orbit's projection on the earth's surface, e.g. if the satellite's orbit passes over the cell center.)

Yet another example:
Semi-major axis.
Eccentricity.
Directional angle, e.g. in relation to north. (This may also be implicit, e.g. if it is assumed to be parallel with the satellite orbit's projection on the earth's surface, e.g. if the satellite's orbit passes over the cell center.)

Yet another example:
Focal distance.
Sum of the distances from a point on the border line to each of the focal points (which is constant for all points on the border according to the definition of an ellipse).
Directional angle, e.g. in relation to north. (This may also be implicit, e.g. if it is assumed to be parallel with the satellite orbit's projection on the earth's surface, e.g. if the satellite's orbit passes over the cell center.)

If the shape to be described is a circle, this can simply be described using a radius, a diameter or a circle circumference.

All the above shape/ellipse/circle descriptions may be complemented with a location of the ellipse or circle, e.g. represented by the center of the ellipse or one of its focal points, e.g. the most southern focal point, or, in the case of a circle, the location of the center point of the circle.

Looking at the idealized case with the coexisting cell principle, where the resulting shape is a symmetric (with respect to a straight line) hexagon (which in a special case becomes a regular hexagon which also has rotational symmetry), this may be described in different ways. One way is to describe the ellipse (or circle in the special case) in which the hexagon is inscribed (i.e. the non-interfered cell area). For that, any of the above described options for describing an ellipse can be reused. To go from this ellipse to the inscribed hexagon, one way is to start with a rotationally symmetric hexagon inscribed in a circle. Then the circle is “stretched” (in the horizontal direction of the satellite beam(s)—i.e. in the direction of the satellite orbit assuming that the satellite's orbit passes right over the served cell) to an ellipse and the inscribed hexagon is stretched together with it. Supposing now that the symmetry line passes orthogonally across the middle of two opposing sides in the hexagon, then process of stretching the hexagon will result in that the two inner angles pointing orthogonally away from the symmetry line are widened by X degrees each, while the remaining four inner angles are narrowed by X/2 degrees each. Furthermore, all distances/measures parallel with the symmetry line (i.e. the direction of stretching, i.e. parallel with the semi-major axis of the ellipse) should be scaled equally much as the ratio between the ellipse's semi-major axis (after the stretch) and the original circle's radius (before the stretch). Distances/measures parallel to the ellipse's semi-major axis (i.e. orthogonal to the direction of stretching) should be subject to scaling equal to the ratio between the ellipse's semi-minor axis (after the stretch) and the original circle's radius (before the stretch). This kind of scaling of the (originally regular) hexagon should result in the above indicated changes of the hexagon's inner angles.

In another idealized example, the symmetry line passes through two opposing corners of the hexagon. After application of the scaling described above, the inner angles coinciding with the symmetry line have been narrowed by X degrees, while the remaining four inner angles have been widened by X/2 degrees.

In a non-idealized scenario, where neighbor cells may have different shapes and sizes as described above, e.g. depending on the current locations of their serving satellites, an irregular (e.g. asymmetric) polygon may be a more suitable way to describe the cell area when the independent cell principle is used. Such a polygon, which typically still would be a hexagon, could be described by coordinates for the polygon's corners. As one option, the full coordinates could be provided for one corner (e.g. called the reference corner) and the locations of the other corners could be indicated in relation to the reference corner, e.g. using vectors. As previously described, as the serving satellite moves and its elevation angle (and the angle with which its beam (or beams) hits the earth's surface) changes, the polygon will be stretched and/or contracted in a way that is predictable based on the satellite's ephemeris data (i.e. based on knowledge of the satellite's orbit and its position as a function of time).

### Orbits and Cell Areas

Normally, the intersection of a cone (such as a satellite beam) and a tilted or untilted plane results in an ellipse or a circle (where an untilted plane is a plane that is perpendicular to the symmetry line of the cone). But, in the context of satellite beams and the ground, the plane (i.e. the surface of the earth) is not flat, but slightly curved, which makes the intersection with the satellite beam cone (i.e. the beam's footprint) result in a shape that deviates slightly from a perfect ellipse. Instead, the radius of curvature of one end (the one closer to the satellite) is slightly larger than the radius of curvature at the other end (the one further away from the satellite), hence resulting in what informally could be referred to as an egg shape. The deviation from a perfect ellipse is larger, but even with large beam footprints, the effective deviation from an ellipse will be rather small.

However, the non-interfered cell area is also impacted by the signal strength that can be received on the ground, which in turn is affected by the distance to the satellite as well as the distance a transmitted signal has to travel through the earth's atmosphere. The downlink signals reaching the far end of the ellipse experience larger dilution and attenuation than downlink signals reaching the close end of the ellipse. This tends to counteract the effect of the elliptic shape that is caused by the earth's curvature, thus further emphasizing that the deviation from an ellipse of a satellite beam's footprint on the ground is not large.

Another aspect that impacts the cell area in the earth fixed beams/cells case is if the serving satellite does not pass right over the cell's center, but rather passes on the side of the cell center. If the serving satellite does not pass over the cell center, then (disregarding possible beamforming compensation) the shape of the non-interfered cell area will never be a circle, but will be an ellipse (of varying eccentricity) whose direction rotates as the serving satellite passes by the cell.

Yet another aspect of satellites orbiting in non-equatorial planes is that such a satellite's projection on the ground as the satellite revolves one lap around its orbit, will not draw a line equivalent to the intersection of a plane with the earth's surface. Instead, the line will have bends, which is a result of the rotation of the earth combined with the orbiting of the satellite. As an example, a satellite in a polar Low Earth Orbit will not follow the line of a longitude, since the longitude moves perpendicular to the satellite's orbit as the earth rotates. Instead, as the satellite moves from a position above the south pole to a position above the north pole, its projection on the ground will follow an “S”-shaped path, starting out in the direction of a first longitude when leaving the south pole position, turning more and more to the left/west as it approaches the equator, then turning right after passing the equator to the northern hemisphere to eventually arrive at the north pole position in the direction of a second longitude (where—if the earth is approximated with a sphere and the satellite orbit is approximated with a circle—the shape of the path followed by the satellite's projection on the ground on the northern hemisphere is equivalent to the shape of the path followed on the southern hemisphere, after reflection in both the equator and the longitude where the path crosses the equator).

Such deviations from straight lines on the earth's surface impacts the satellite's beam footprint(s) in the earth fixed beam/cell case. For instance, even if the satellite passes right over the cell's center, the orientation of the elliptic non-interfered cell area will not be constant, but will “wiggle” as a result of the bends of the path of the projection on the ground of the serving satellite (unless the satellite strives to compensate for this using advanced beamforming techniques).

Yet another aspect that impacts the cell area in the earth fixed beam/cell case is the switches of the serving satellite (i.e. the satellite covering the earth fixed geographical area with downlink transmissions). At such switches, the shape of the cell area will change momentarily, unless very advanced beamforming is used to compensate for the effects of the switch. It may be noted, however, that in principle the cell will also be switched when the satellite is switched, in which case it is a matter of definition whether the cell coverage information, e.g. a time dependent part of the cell coverage information, should take into account the cell coverage area after a satellite switch or whether the information pertaining to the cell after the satellite switch should be regarded as separate cell coverage information pertaining to another cell. Both options may be applicable and may be seen as different embodiments.

In some embodiments, the aspects described in this section may be taken into account in the descriptions of cell coverage areas/shapes and/or in the time dependence of such descriptions or cell coverage areas/shapes.

### Reuse and Adaptation/Modification of Area/Shape Definitions and Encoding in 3GPP TS 23.032

As described above, 3GPP has already standardized a set of shape definitions to be used for describing areas on the surface of the earth in 3GPP TS 23.032 where the surface of the earth is represented by the World Geodetic System 1984 (WGS 84) ellipsoid. These definitions may be reused, to the extent they are suitable for the purposes described herein. However, since certain embodiments described herein may require properties of the shape/area descriptions that are not fully met by the already specified ones, 3GPP TS 23.032 should preferably be extended/modified to cover a wider range of shape/area descriptions, in line with what has been indicated in the respective embodiments above. Such extensions/modifications may include extensions of the value ranges of certain parameters in order to include larger maximum values and thus allowing larger areas/shapes to be described. Parameters whose ranges may be subject for such extensions may, for example, include parameters representing a circle's radius, the semi-minor axis and/or semi-major axis of an ellipse, the side/edge of a polygon (i.e. the straight line connecting two points representing corners in a polygon), and/or the maximum number of points representing the corners of polygon. Other extensions/modifications that may be useful include, for example, a possibility to describe a distorted ellipse such as, for example, slightly egg shaped.

One example of the above mentioned modifications is given below for Radius described is section 6 in 3GPP TS 23.032. In the below example, the existing text in the specification has been modified and the equation has been rewritten in accordance with certain embodiments described herein:
Inner radius is encoded in increments of Y meters using an x bit binary coded number N and in addition minimum radius of M meters. The relation between the number M, N, Y and the range of radius r (in metres) it encodes is described by the following equation:

$$YN + M \leq r < M + Y ( N + 1 )$$

Except for N=2^{x}−1 for which the range is extended to include all greater values of r.

The advantage of the above formulation compared to the existing formulation is firstly in its flexibility. This comes with the cost of having X, Y and M as variables. However, even if these are fixed and we only keep N as a variable similar to the existing specification, the new formulation gives advantages in the NTN context as the value M can be set to the minimum NTN cell radius, say 400 meters, and the bits used in N can be used to increment from 400 meters to the needed maximum cell size. The values X, Y and M may be fixed in a specification, or preconfigured for the UE, or given over RRC or NAS signaling, e.g. as part of ephemeris data or cell coverage area data for a certain system. E.g. LEO and GEO systems may have different values. Alternatively, the values X, Y and M may be given in long term system information (e.g. infrequently broadcast system information or system information available only on demand) while N may be given in short term system information (e.g. more frequently broadcast system information). A similar approach may be used for an ellipse to make it more accurately represent a (non-interfered) cell coverage area with optimized use of bits for an NTN system.

Extensions/modifications related to the polygon representation may be particularly useful in the case where an actual cell area is to be described, i.e. taking the interference of other cells into account, especially in a scenario where the cell is covered/served by a bundle of beams. For descriptions of a non-interfered cell area, e.g. extensions/modifications of circle or ellipse parameters/descriptions may be useful.

### Provision/Transfer/Signaling of Cell Coverage Area Information to a UE

According to certain embodiments and as described above, the cell coverage area information may be conveyed to a UE in various ways. As one option, it may be conveyed through the system information in the cell, which may be broadcast periodically or broadcast on request. It may also be conveyed as system information delivered in a dedicated RRC message, e.g. an RRCReconfiguration message constituting a Handover Command. Other forms of dedicated signaling may also be used such as, for example, MAC layer messages (in the form of one or more MAC Control Element(s)) or RRC layer messages.

The cell coverage area information delivered to a UE may contain information pertaining to a single cell or multiple cells. In case of a single cell, this may be the serving cell (i.e. the cell the UE currently is camping on or is connected in and which is the cell in which the UE receives the cell coverage area information) or another (non-serving) cell. If the cell coverage area information pertains to a non-serving cell, this may, for example, be a neighbor cell, a soon to be neighbor cell, a cell which will soon cover the UE's location due to cell movements in the moving beams/cells case, a cell which will soon cover the UE's location due to satellite/cell switch(es) in the earth fixed beams/cells case, or any other cell. If the cell coverage area information provided to a UE pertains to multiple cells, these cells may include, for example, neighbor cells, soon to be neighbor cells, cells which will cover the same location after satellite and cell switches in the earth fixed beam/cell case (e.g. covering a certain number of coming satellite switches or a certain time into the future), cells which will cover the same location over time due to cell movements in the moving beam/cell case (e.g. during a certain time period into the future), or even all cells in the network. In addition, the serving cell may be one of the multiple cells to which the conveyed cell coverage area information pertains.

In a particular embodiment, cell coverage area information may also be delivered in a dedicated message after a generic or specific request from a UE. A specific request may specify which cell(s) the coverage area information should pertain to, and possibly restrictions in the time dependence information to be delivered. The restrictions in the time dependence information may for instance have the form of a limit on how far into the future the time dependence information should apply, e.g. with the purpose of limiting the amount of data to be transferred. Similarly, a data amount limit may be specified for the time dependence information or for the cell coverage area information as a whole, which in practice means that the time into the future during which the time dependence information is applicable is restricted. In a request for cell coverage information, a UE could also ask for information pertaining to cell(s) in whose coverage areas the UE's current position will be located during some part of a certain time period, e.g. spanning from now into a certain time in the future. Such a request could contain the UE's current position and/or an indication of the applicable time period (which also may be standardized).

A request for cell coverage area information of interest for the UE's current position may also be extended to include more cells than the ones which will cover the UE's location during a certain time period, e.g. including also cells whose edges/borders will be close to the UE's location. Such a cell may be of interest, because, even though the UE's location “nominally” is outside the cell, it may be good enough to select for camping or connecting. It may also be the case that the UE does not remain stationary and then cells close to the UE's current location may be relevant. One way of specifying which cells that “qualify” for inclusion in the cell coverage information according to this principle could be cells whose non-interfered coverage area includes the UE's current position (now, i.e. at the time of the request (or at the time of the response to the request), or at some time during a certain time period).

In some embodiments, different ones of the above options may be used in parallel and/or in combination with each other, depending on situation, configuration or UE preferences, network preferences or operator preferences.

In some embodiments, parts of the cell coverage information may be provided using one or some of the above described means while other parts of the cell coverage information may be provided using one or more other of the above described means.

As described in more detail above, cell coverage area information may be signaled in the form of explicit parameters, e.g. shape-defining parameters of the types described in section 0 and 3GPP TS 23.032 and/or parameters related to mathematical formulae, e.g. for expressing time dependence. In other embodiments, one or more sets or tables of area descriptions and/or time dependence formulae may be specified in standard specification(s) and the signaling of the coverage information would then consist of one or more index(es) pointing into the standardized set(s)/table(s). This would serve to make the signaling more compact. It is also possible to combine signaling of index(es) (pointing into standardized set(s)/table(s)) with explicit parameters, in particular embodiments. For instance, an index pointing at a shape description could be combined with an explicit signaling of an earth location, indicating where on the earth's surface the shape should be placed to represent a cell coverage area.

### Usage of Cell Coverage Information in a UE

According to certain embodiments, a UE can utilize obtained cell coverage information to improve its operation in any kind of cell (re) selection procedure or RRC_CONNECTED state mobility procedure, which the UE can perform or determine autonomously (as a whole or in part).

For instance, a UE can use the cell coverage information to determine how long it can expect to be covered by a certain cell, e.g. one of possibly multiple cells that the UE can choose to camp on or connect in at the UE's present location. A cell with long expected time to be served may be prioritized over a cell with short expected time to be served.

As another example, a UE may use the expected time to be served obtained from the cell coverage information as input to a decision whether to execute a conditional mobility operation in RRC_CONNECTED state, state, such as conditional handover, conditional PSCell addition, conditional PSCell change and/or conditional SCell addition.

Furthermore, the cell coverage information may facilitate a cell search operation for a UE such as, for example, because it enables a UE to know which cells that may be possible to detect at the UE's current location. This may allow the UE to exclude certain cells and/or satellites from the cell search and thereby potentially limit the number of directions (or the total solid angle) the UE has to search in and/or the number of carrier frequencies the UE has to search on.

One can also envision future operations in which the UE suggests to its gNB, which cell(s) that may be suitable for a certain operation, e.g. related to mobility (such as suggesting a candidate target cell to be included in a conditional handover configuration).

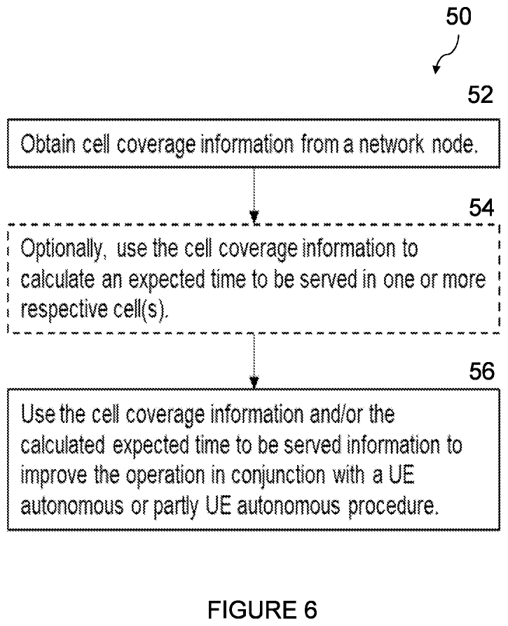

FIG. 6 illustrates an example method 50 of a UE's operation, according with embodiments. At step 52, the UE obtains cell coverage information from a network node. Typically, the UE may obtain the cell coverage information from a network node in a NTN, e.g. gNB serving NTN cells. In other embodiments, the UE may obtain the cell coverage information from a network node in a Terrestrial Network, e.g. a gNB controlling an NR cell (or an eNB controlling an LTE cell) which is the UE's serving cell. Irrespective of the source of the cell coverage information, the cell coverage information would in preferred embodiments pertain to NTN cell(s), but embodiments where the cell coverage area information pertains to Terrestrial Network cell(s) are not excluded.

At an optional step 54, the UE uses the cell coverage information to calculate an expected time to be served in one or more cells. At step 56, the UE uses the cell coverage information and/or the calculated expected time to be served information to improve the operation in conjunction with a UE autonomous or partly UE autonomous procedure.

Information described above as being provided to or used by the UE may also be provided to or used by the base station, instead of or in addition to the UE, and appropriate calculations can be made by either the UE, base station, or both, if needed. In some embodiments, when the information is provided to the base station, the base station may in turn provide the information, fully or in parts, to the UE or it may provide information to the UE which results from processing of the received information, e.g. results of the above mentioned appropriate calculations, and/or it may use the received information to improve the operation in relation to the UE.

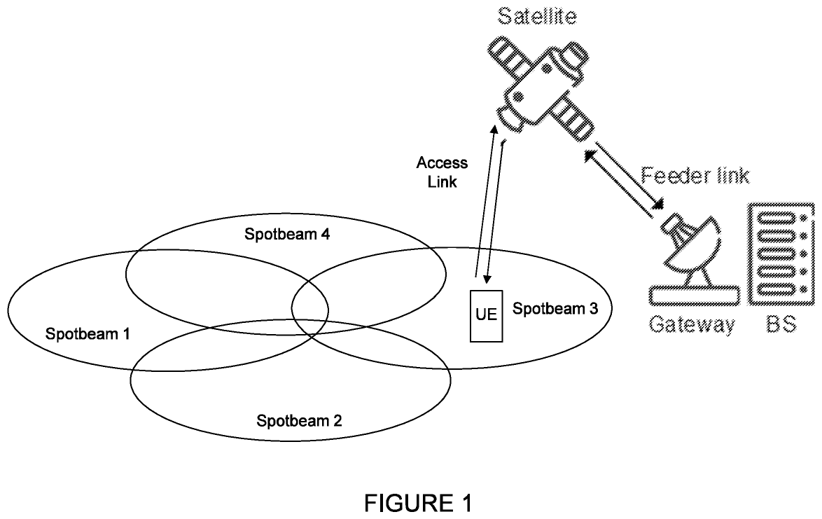

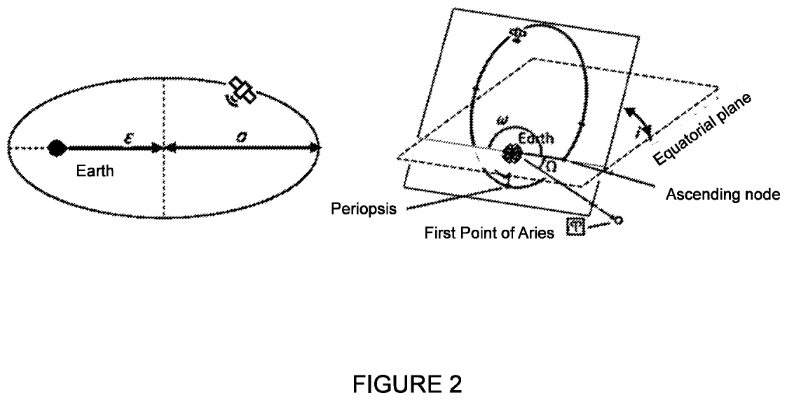

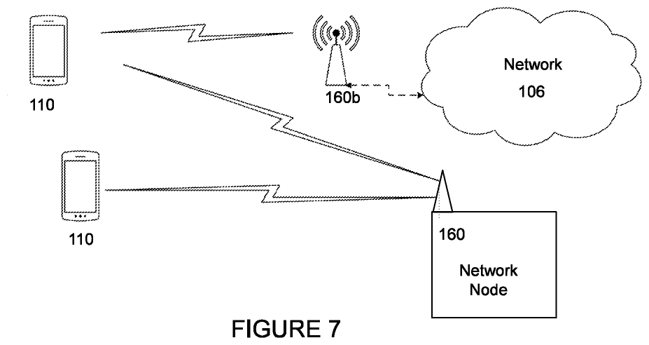

FIG. 7 illustrates a wireless network in accordance with some embodiments. Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 106, network nodes 160 and 160b, and WDs 110. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. In the case where a bent pipe satellite network architecture (also referred to as the transparent payload architecture) is employed, network node 160 may communicate at least some information with WD 110 using a satellite and a gateway, as illustrated in FIG. 1. In the case where a regenerative payload satellite architecture is employed, 160 may be located on a satellite that provides information to and from WD 160. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below, and as described above with respect to NTN. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

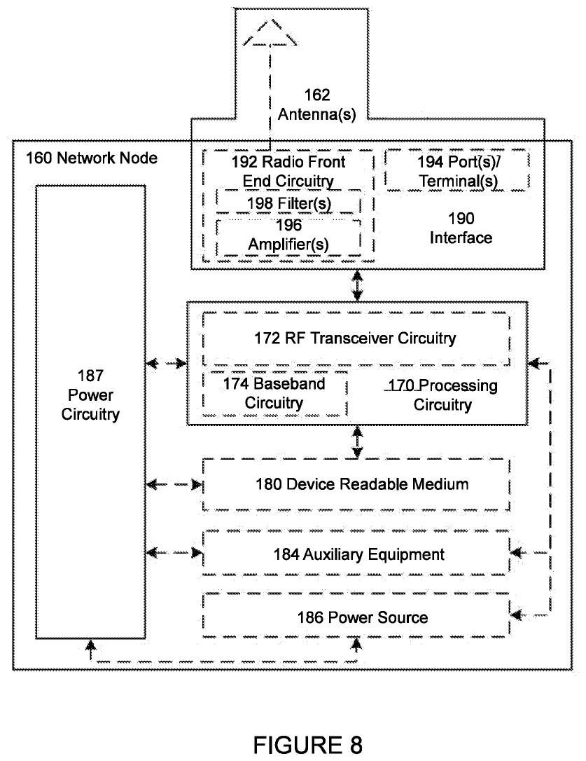

FIG. 8 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 160 includes processing circuitry 170, device readable medium 180, interface 190, auxiliary equipment 184, power source 186, power circuitry 187, and antenna 162. Although network node 160 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 190 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port. In the case where a bent pipe satellite network architecture (also referred to as the transparent payload architecture) is employed, antenna 162 may transmit and receive information between network node 160 and a satellite over a feeder link. Alternatively, network node 160 may communicate in a wired or wireless manner with a gateway that in turn communicates with a satellite over a feeder link.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 8 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

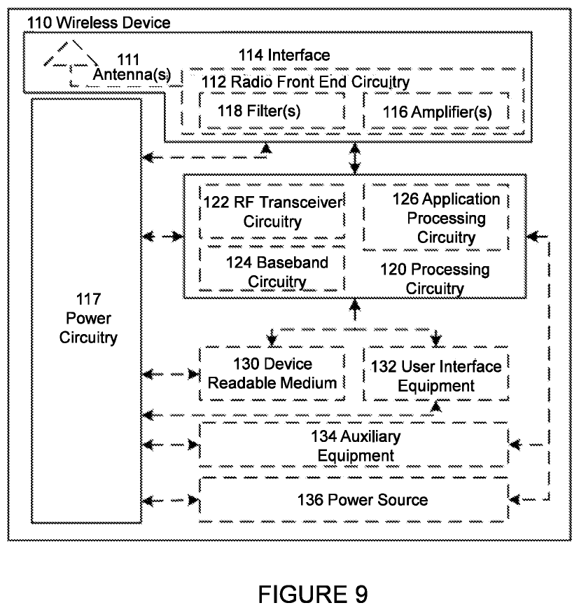

FIG. 9 illustrates an example wireless device (WD) 110, according to certain embodiments. As used herein, WD refers to a device capable, configured, arranged and/or operable to communicate wirelessly with network nodes and/or other wireless devices. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc., A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 114 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality.

Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

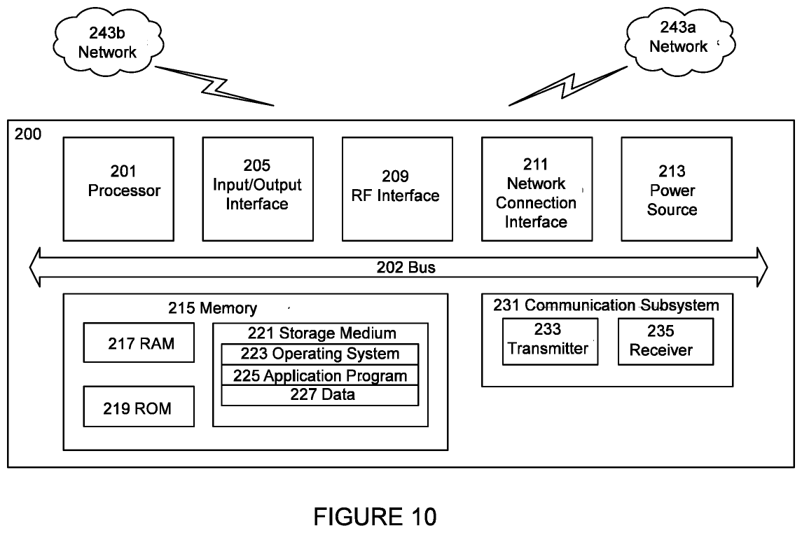

FIG. 10 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

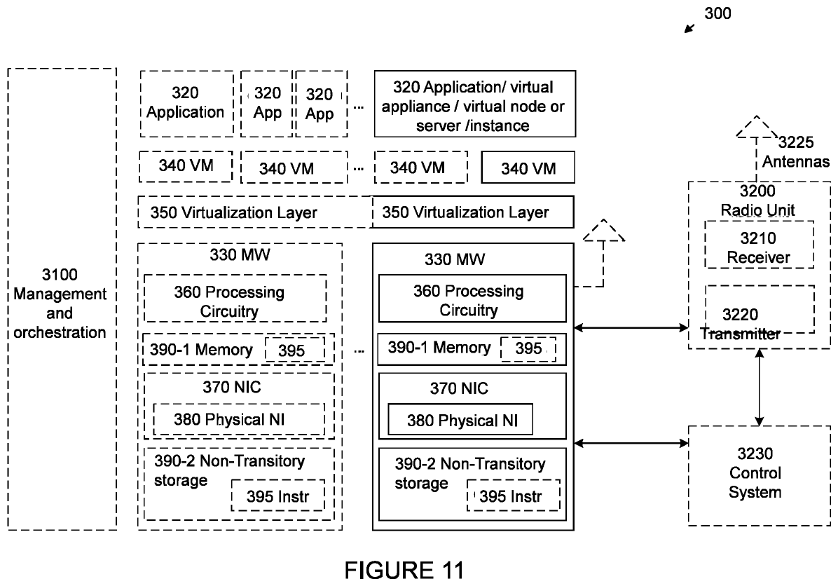

FIG. 11 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 11, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 11.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

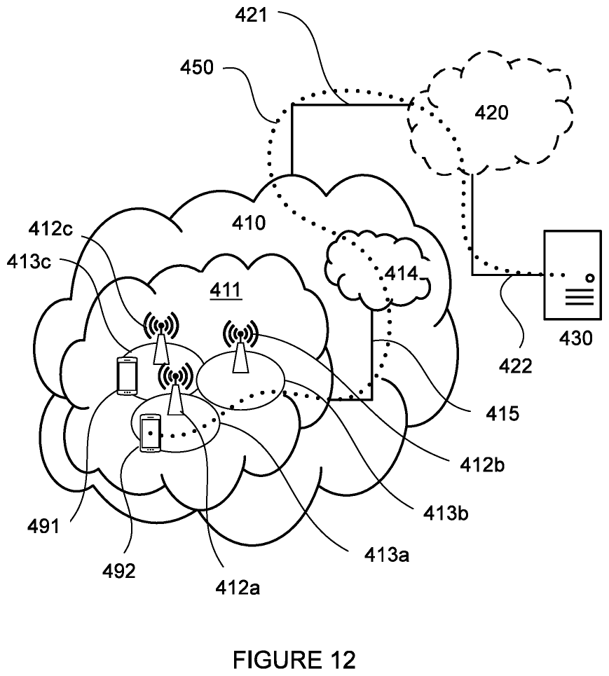

FIG. 12 illustrates a telecommunication network connected via an intermediate network to a host computer in accordance with some embodiments. Specifically, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. These coverage areas may result from use of satellite communications as described above with respect to FIG. 7, in some embodiments. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 12 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

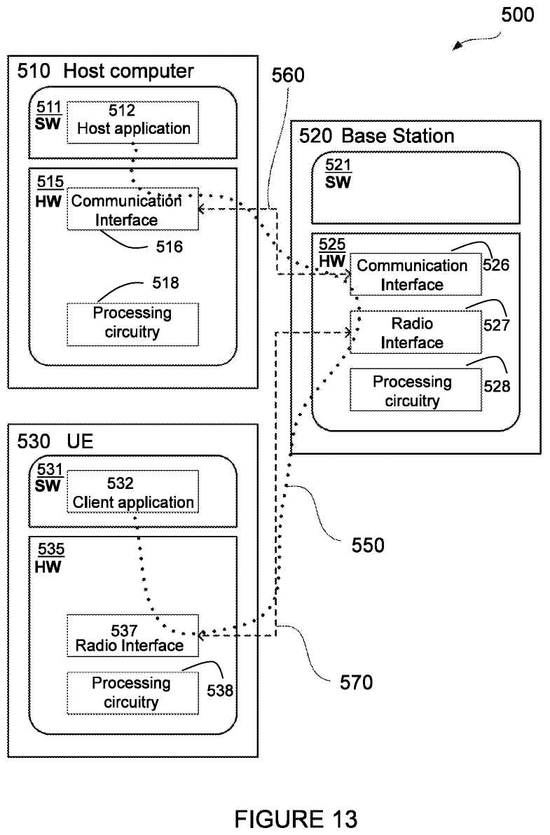

Example implementations, in accordance with an embodiment, of the UE, base station and host computer discussed in the preceding paragraphs will now be described. FIG. 13 illustrates a host computer communicating via a base station with a user equipment over a partially wireless connection in accordance with some embodiments

In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 13) served by base station 520. This wireless communication may include satellites, in some embodiments, as illustrated in FIG. 7. Communication interface 526 may be configured to facilitate connection 560 to host computer 510. Connection 560 may be direct or it may pass through a core network (not shown in FIG. 13) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 13 may be similar or identical to host computer 430, one of base stations 412a, 412b, 412c and one of UEs 491, 492 of FIG. 12, respectively. This is to say, the inner workings of these entities may be as shown in FIG. 13 and independently, the surrounding network topology may be that of FIG. 12.

In FIG. 13, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate, latency, and power consumption and thereby provide benefits such as reduced user waiting time, relaxed restriction on file size, better responsiveness, and extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

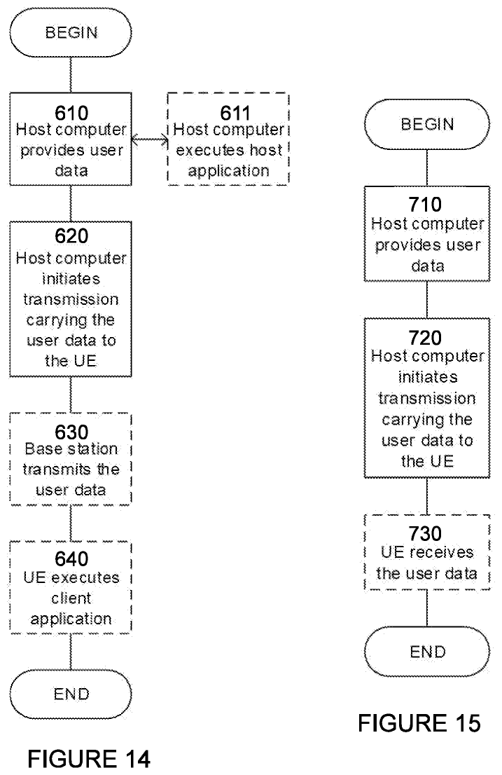

FIG. 14 illustrates methods implemented in a communication system including a host computer, a base station and a user equipment in accordance with some embodiments. The communication system includes a host computer, a base station and a UE which may be those described with reference to FIGS. 12 and 13. For simplicity of the present disclosure, only drawing references to FIG. 14 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 15 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 15 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

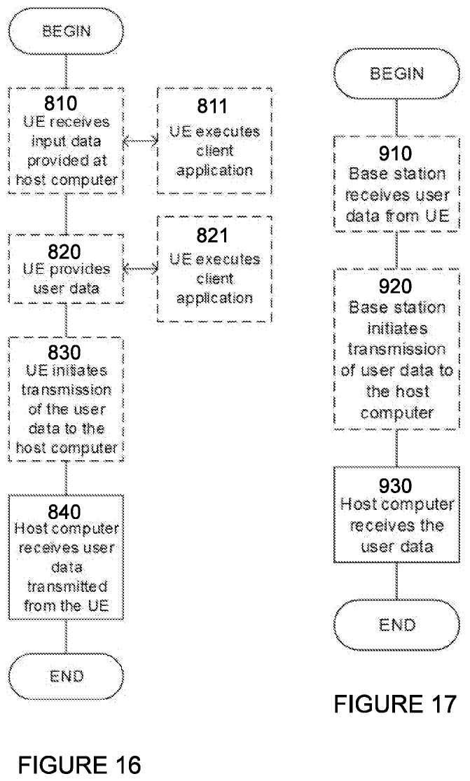

FIG. 16 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 16 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station and a UE which may be those described with reference to FIGS. 12 and 13. For simplicity of the present disclosure, only drawing references to FIG. 17 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

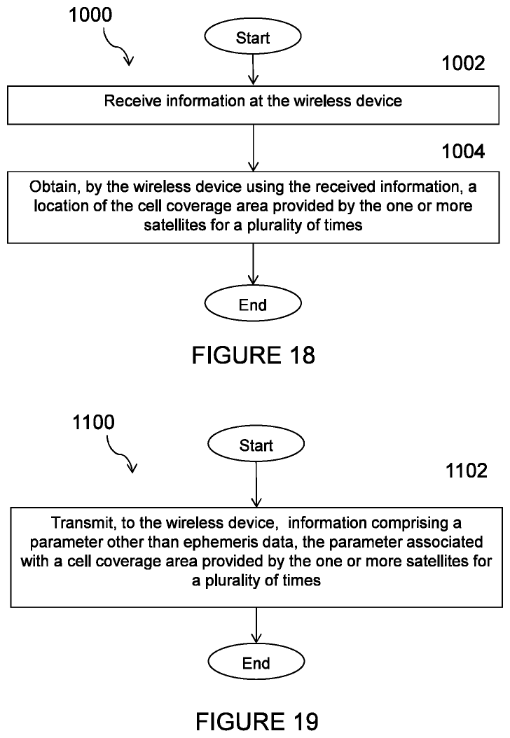

FIG. 18 illustrates a method 1000 by a wireless device 110 for determining cell coverage area provided by one or more satellites, according to certain embodiments. The method begins at step 1002 when information is received at the wireless device 110. At step 1004, the wireless device 110 obtains, using the received information, a location of the cell coverage area provided by the one or more satellites for a plurality of times.

In a particular embodiment, obtaining comprises calculating.

In a particular embodiment, the received information specifies how a shape of the cell coverage area provided by the one or more satellites varies with time.

In a particular embodiment, the wireless device 110 determines, based on the received information, how a shape of the cell coverage area provided by the one or more satellites varies with time.

In a particular embodiment, the received information includes a plurality of shape descriptions of the cell coverage area provided by one or more satellites at respective times. In a further particular embodiment, the plurality of shape descriptions comprises a shape of the cell coverage area at a first time and a difference of the shape at a second time from the shape at the first time.

In a further particular embodiment, the received information comprises a mathematical formula that specifies the shape of the cell coverage area provided by the one or more cells as a function of time.

In a particular embodiment, the received information comprises ephemeris data of the one or more satellites and information regarding a respective beam produced by each of the one or more satellites to provide the cell coverage area.

In a further particular embodiment, the information regarding a respective beam produced by each of the one or more satellites to provide the cell coverage area comprises a size and shape of a footprint of the respective beam at the surface of the earth at a respective elevation angle or a respective time.

In a particular embodiment, the information regarding a respective beam produced by each of the one or more satellites to provide the cell coverage area comprises an angle of the beam. In a further particular embodiment, the angle of the beam is indicated in relation to: a nadir direction in relation to a particular one of the one or more satellites, or a surface of the earth.

In a further particular embodiment, the information regarding a respective beam produced by each of the one or more satellites to provide the cell coverage area comprises a solid angle of the respective beam produced by each of the one or more satellites to provide the cell coverage area together with the direction of the respective beam at a given point in time.

In a particular embodiment, the received information comprises at least one of: one or more cell coverage area descriptions with associated time stamps; a reference cell coverage area along with information from which an associated satellite elevation angle can be determined; a reference satellite elevation angle along with information from which an associated reference cell coverage area or an associated reference satellite beam footprint can be determined; a center location of the cell coverage area; a solid angle of a satellite beam representing a non-interfered cell coverage area; a solid angle of a plurality of satellite beams whose combined footprint represents a non-interfered cell area; a solid angle of each satellite beam in a plurality of beams whose combined footprint represents a non-interfered cell coverage area; a direction of a satellite beam, whose footprint represents a non-interfered cell coverage area; a direction of a bundle of satellite beams whose combined footprint represents a non-interfered cell coverage area; a direction of each satellite beam in a bundle of beams whose combined footprint represents a non-interfered cell coverage area; and satellite ephemeris data.

In a particular embodiment, the received information is received in a cell defined by the cell coverage area. In a further particular embodiment, the received information is received by a broadcast or in a RRC message.

In a particular embodiment, the wireless device 110 requests the information.

In a particular embodiment, the wireless device 110 determines a time the wireless device can expect to be covered by a cell defined by the cell coverage area.

In a particular embodiment, the wireless device 110 determines, based at least in part on the determined time, whether to execute a conditional mobility operation.

In a particular embodiment, the wireless device 110 determines which of a plurality of cells may be suitable for a certain mobility operation.

In a particular embodiment, the wireless device 110 uses the cell coverage area in effecting a cell selection procedure.

FIG. 19 illustrates a method 1100 performed by a base station 160 for providing information for determining cell coverage area provided by one or more satellites, according to certain embodiments. The method begins at step 1102 when the network node 160 transmits, to the wireless device 110, information comprising a parameter other than ephemeris data. The parameter is associated with a cell coverage area provided by the one or more satellites for a plurality of times.

In a particular embodiment, the information indicates how a shape of the cell coverage area provided by the one or more satellites varies with time.

In a particular embodiment, the information includes a plurality of shape descriptions of the cell coverage area provided by one or more satellites at respective times.

In a particular embodiment, the plurality of shape descriptions comprises a shape of the cell coverage area at a first time and a difference of the shape at a second time from the shape at the first time.

In a particular embodiment, the information comprises a mathematical formula that specifies the shape of the cell coverage area provided by the one or more cells as a function of time.

In a particular embodiment, the information further comprises ephemeris data of the one or more satellites and information regarding a respective beam produced by each of the one or more satellites to provide the cell coverage area.

In a particular embodiment, the information regarding a respective beam produced by each of the one or more satellites to provide the cell coverage area comprises a size and shape of a footprint of the respective beam at the surface of the earth at a respective elevation angle or a respective time.

In a particular embodiment, the information regarding a respective beam produced by each of the one or more satellites to provide the cell coverage area comprises an angle of the beam.

In a particular embodiment, the angle of the beam is indicated in relation to: a nadir direction in relation to a particular one of the one or more satellites, or a surface of the earth.

In a particular embodiment, the information regarding a respective beam produced by each of the one or more satellites to provide the cell coverage area comprises a solid angle of the respective beam produced by each of the one or more satellites to provide the cell coverage area together with the direction of the respective beam at a given point in time.

In a particular embodiment, the information comprises at least one of: one or more cell coverage area descriptions with associated time stamps; a reference cell coverage area along with information from which an associated satellite elevation angle can be determined; a reference satellite elevation angle along with information from which an associated reference cell coverage area or an associated reference satellite beam footprint can be determined; a center location of the cell coverage area; a solid angle of a satellite beam representing a non-interfered cell coverage area; a solid angle of a plurality of satellite beams whose combined footprint represents a non-interfered cell area; a solid angle of each satellite beam in a plurality of beams whose combined footprint represents a non-interfered cell coverage area; a direction of a satellite beam, whose footprint represents a non-interfered cell coverage area; a direction of a bundle of satellite beams whose combined footprint represents a non-interfered cell coverage area; a direction of each satellite beam in a bundle of beams whose combined footprint represents a non-interfered cell coverage area; and satellite ephemeris data.

In a particular embodiment, the information is transmitted in a cell defined by the cell coverage area.

In a particular embodiment, the information is transmitted by a broadcast or in a RRC message.

In a particular embodiment, the network node 160 receives, from the wireless device 110, a request for the information.

### EXAMPLE EMBODIMENTS

### Group A Embodiments

Example Embodiment 1. A method used in satellite communications for determining cell coverage area provided by one or more satellites, the method comprising: receiving information at a wireless device; and obtaining by the wireless device using the received information, a shape of the cell coverage area provided by the one or more satellites at a particular time.

Example Embodiment 2. The method of example embodiment 1, 22, 30, 31, 32, or 33, wherein obtaining comprises calculating.

Example Embodiment 3. The method of example embodiment 1 or 31, wherein the received information specifies how the shape of the cell coverage area provided by the one or more satellites varies with time.

Example Embodiment 4. The method of example embodiment 1 or 31, wherein the received information enables the wireless device to determine how the shape of the cell coverage area provided by the one or more satellites varies with time.

Example Embodiment 5. The method of example embodiment 3, wherein the received information includes a plurality of shape descriptions of the cell coverage area provided by one or more satellites at respective times.

Example Embodiment 6. The method of example embodiment 5, wherein the plurality of shape descriptions comprises a shape of the cell coverage area at a first time and a difference of the shape at a second time from the shape at the first time.

Example Embodiment 7. The method of example embodiment 3, wherein the received information comprises a mathematical formula that specifies the shape of the cell coverage area provided by the one or more cells as a function of time.

Example Embodiment 8. The method of example embodiment 4, wherein the received information comprises ephemeris data of the one or more satellites and information regarding a respective beam produced by each of the one or more satellites to provide the cell coverage area.

Example Embodiment 9. The method of example embodiment 8, wherein the information regarding a respective beam produced by each of the one or more satellites to provide the cell coverage area comprises a size and shape of a footprint of the respective beam at the surface of the earth at a respective elevation angle or a respective time.

Example Embodiment 10. The method of example embodiment 8, wherein the information regarding a respective beam produced by each of the one or more satellites to provide the cell coverage area comprises a solid angle of the respective beam produced by each of the one or more satellites to provide the cell coverage area together with the direction of the respective beam at a given point in time.

Example Embodiment 11. The method of example embodiment 1 or 22 or 30, wherein the wireless device further obtains, using the received information, the location of the cell coverage area on the earth or on a WGS 84 ellipsoid.

Example Embodiment 12. The method of example embodiments 1, 22, 30, 31, 32, or 33, wherein the received information comprises at least one of: one or more cell coverage area descriptions with associated time stamps; one or more mathematical formula describing the cell coverage area as a function of time or a plurality of parameters related to properties of the cell coverage area as a function of time; a reference cell coverage area along with information from which an associated satellite elevation angle can be determined; a reference satellite elevation angle along with information from which an associated reference cell coverage area or an associated reference satellite beam footprint can be determined; a center location of the cell coverage area; a solid angle of a satellite beam representing a non-interfered cell coverage area; a solid angle of a plurality of satellite beams whose combined footprint represents a non-interfered cell area; a solid angle of each satellite beam in a plurality of beams whose combined footprint represents a non-interfered cell coverage area; a direction of a satellite beam, whose footprint represents a non-interfered cell coverage area; a direction of a bundle of satellite beams whose combined footprint represents a non-interfered cell coverage area; a direction of each satellite beam in a bundle of beams whose combined footprint represents a non-interfered cell coverage area; and satellite ephemeris data.

Example Embodiment 13. The method of example embodiment 1, 22, or 31, wherein the received information is received in a cell defined by the cell coverage area.

Example Embodiment 14. The method of example embodiment 13, wherein the received information is received by a broadcast.

Example Embodiment 15. The method of example embodiment 13, wherein the received information is received in an RRC message.

Example Embodiment 16. The method of example embodiment 15, wherein the RRC message is dedicated RRC message or a unicast RRC message.

Example Embodiment 17. The method of example embodiment 1, 22, 30, 31, 32, or 33, and further comprising requesting the information.

Example Embodiment 18. The method of example embodiment 1, 22, 30, 31, 32, or 33, and further comprising determining a time the wireless device can expect to be covered by a cell defined by the cell coverage area.

Example Embodiment 19. The method of example embodiment 18, and further comprising determining, based at least in part on the determined time, whether to execute a conditional mobility operation.

Example Embodiment 20. The method of example embodiment 1, 22, 30, 31, 32, or 33, and further comprising determining which of a plurality of cells may be suitable for a certain mobility operation.

Example Embodiment 21. The method of example embodiment 1, 22, 30, 31, 32, or 33, and further comprising using the cell coverage area in effecting a cell selection procedure.

Example Embodiment 22. A method used in satellite communications for determining cell coverage area provided by one or more satellites, the method comprising: receiving information at a wireless device; and obtaining by the wireless device using the received information, a shape, a size, and a location of the cell coverage area provided by the one or more satellites for a plurality of times.

Example Embodiment 23. The method of example embodiment 22, 29, 32, or 33, wherein the received information includes ephemeris data for the one or more satellites and information regarding a beam produced by each of the one or more satellites.

Example Embodiment 24. The method of example embodiment 23, wherein the information regarding a beam produced by each of the one or more satellites comprises a solid angle and direction in relation to a nadir direction of each respective satellite.

Example Embodiment 25. The method of example embodiment 23, wherein the information regarding a beam produced by each of the one or more satellites comprises a solid angle and direction in relation to the earth's surface of each respective satellite.

Example Embodiment 26. The method of example embodiment 22 or 32, wherein the received information comprises a reference coverage area at a respective time and ephemeris data for the one or more satellites.

Example Embodiment 27. The method of example embodiment 22, 29, 32, or 33, wherein the received information comprises the cell coverage area for a plurality of respective times.

Example Embodiment 28. The method of example embodiment 1, 22, 30, 31, 32, or 33, wherein the received information comprises a distance between one of the one or more satellites and at least one other satellite.

Example Embodiment 29. The method of example embodiment 19 or 28, wherein obtaining, by the wireless device using the received information, a shape, size, and location of the cell coverage area provided by the one or more satellites for a plurality of times comprises using a previous shape or size of the cell coverage area as a current shape or size of the cell coverage area.

Example Embodiment 30. A method used in satellite communications for determining cell coverage area provided by one or more satellites, the method comprising: receiving information at a wireless device; and obtaining, by the wireless device using the received information. a location of the cell coverage area provided by the one or more satellites for a plurality of times.

### Group B Embodiments

Example Embodiment 31. A method used in satellite communications for determining cell coverage area provided by one or more satellites, the method comprising: receiving information at a base station; and obtaining, by the base station using the received information, a shape of the cell coverage area provided by the one or more satellites at a particular time.

Example Embodiment 32. A method used in satellite communications for determining cell coverage area provided by one or more satellites, the method comprising: receiving information at a base station; and obtaining, by the base station using the received information, a shape, a size, and a location of the cell coverage area provided by the one or more satellites for a plurality of times.

Example Embodiment 33. A method performed by a base station for determining cell coverage area provided by one or more satellites, the method comprising: receiving information at the base station; and obtaining, by the base station using the received information, a location of the cell coverage area provided by the one or more satellites for a plurality of times.

Example Embodiment 33b. The method of any of the previous embodiments, further comprising: providing user data; and forwarding the user data to a host computer via the transmission to the base station.

### Group C Example Embodiments

Example Embodiment 34. A wireless device comprising: processing circuitry configured to perform any of the steps of any of the Group A example embodiments; and power supply circuitry configured to supply power to the wireless device.

Example Embodiment 35. A base station comprising: processing circuitry configured to perform any of the steps of any of the Group B example embodiments; power supply circuitry configured to supply power to the base station.

Example Embodiment 36. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment 37. A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group B embodiments.

Example Embodiment 38. The communication system of the previous example embodiment further including the base station.

Example Embodiment 39. The communication system of the previous 2 example embodiments, further including the UE, wherein the UE is configured to communicate with the base station.

Example Embodiment 40. The communication system of the previous 3 example embodiments, wherein: the processing circuitry of the host computer is configured to execute a host application, thereby providing the user data; and the UE comprises processing circuitry configured to execute a client application associated with the host application.

Example Embodiment 41. A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group B embodiments.

Example Embodiment 42. The method of the previous example embodiment, further comprising, at the base station, transmitting the user data.

Example Embodiment 43. The method of the previous 2 example embodiments, wherein the user data is provided at the host computer by executing a host application, the method further comprising, at the UE, executing a client application associated with the host application.

Example Embodiment 44. A user equipment (UE) configured to communicate with a base station, the UE comprising a radio interface and processing circuitry configured to performs the of the previous 3 example embodiments.

Example Embodiment 45. A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of the Group A example embodiments.

Example Embodiment 46. The communication system of the previous example embodiment, wherein the cellular network further includes a base station configured to communicate with the UE.

Example Embodiment 47. The communication system of the previous 2 example embodiments, wherein: the processing circuitry of the host computer is configured to execute a host application, thereby providing the user data; and the UE's processing circuitry is configured to execute a client application associated with the host application.

Example Embodiment 48. A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of the Group A embodiments.

Example Embodiment 49. The method of the previous example embodiment, further comprising at the UE, receiving the user data from the base station.

Example Embodiment 50. A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of the Group A embodiments.

Example Embodiment 51. The communication system of the previous example embodiment, further including the UE.

Example Embodiment 52. A communication system of the previous 2 example embodiments, further including the base station, wherein the base station comprises a radio interface configured to communicate with the UE and a communication interface configured to forward to the host computer the user data carried by a transmission from the UE to the base station.

Example Embodiment 53. The communication system of the previous 3 example embodiments, wherein: the processing circuitry of the host computer is configured to execute a host application; and the UE's processing circuitry is configured to execute a client application associated with the host application, thereby providing the user data.

Example Embodiment 54. The communication system of the previous 4 example embodiments, wherein: the processing circuitry of the host computer is configured to execute a host application, thereby providing request data; and the UE's processing circuitry is configured to execute a client application associated with the host application, thereby providing the user data in response to the request data.

Example Embodiment 55. A method implemented in a communication system including a host computer, a base station and a user equipment (UE), the method comprising: at the host computer, receiving user data transmitted to the base station from the UE, wherein the UE performs any of the steps of any of the Group A embodiments.

Example Embodiment 56. The method of the previous example embodiment, further comprising, at the UE, providing the user data to the base station.

Example Embodiment 57. The method of the previous 2 example embodiments, further comprising: at the UE, executing a client application, thereby providing the user data to be transmitted; and at the host computer, executing a host application associated with the client application.

Example Embodiment 58. The method of the previous 3 example embodiments, further comprising: at the UE, executing a client application; and at the UE, receiving input data to the client application, the input data being provided at the host computer by executing a host application associated with the client application, wherein the user data to be transmitted is provided by the client application in response to the input data.

Example Embodiment 59. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B example embodiments.

Example Embodiment 60. The communication system of the previous example embodiment further including the base station.

Example Embodiment 61. The communication system of the previous 2 example embodiments, further including the UE, wherein the UE is configured to communicate with the base station.

Example Embodiment 62. The communication system of the previous 3 example embodiments, wherein: the processing circuitry of the host computer is configured to execute a host application; the UE is configured to execute a client application associated with the host application, thereby providing the user data to be received by the host computer.

Example Embodiment 63. A method implemented in a communication system including a host computer, a base station and a user equipment (UE), the method comprising: at the host computer, receiving, from the base station, user data originating from a transmission which the base station has received from the UE, wherein the UE performs any of the steps of any of the Group A example embodiments.

Example Embodiment 64. The method of the previous example embodiment, further comprising at the base station, receiving the user data from the UE.

Example Embodiment 65. The method of the previous 2 example embodiments, further comprising at the base station, initiating a transmission of the received user data to the host computer.

1. A method by a wireless device for determining cell coverage area provided by one or more satellites, the method comprising:
receiving information at the wireless device; and
obtaining, by the wireless device using the received information, a location of the cell coverage area provided by the one or more satellites for a plurality of times.

2. (canceled)

3. The method of claim 1, wherein the received information specifies how a shape of the cell coverage area provided by the one or more satellites varies with time.

4. The method of claim 1, further comprising determining, based on the received information, how a shape of the cell coverage area provided by the one or more satellites varies with time.

5. The method of claim 4, wherein the received information includes a plurality of shape descriptions of the cell coverage area provided by one or more satellites at respective times.

6.-7. (canceled)

8. The method of claim 1, wherein the received information comprises ephemeris data of the one or more satellites and information regarding a respective beam produced by each of the one or more satellites to provide the cell coverage area.

9. The method of claim 8, wherein the information regarding a respective beam produced by each of the one or more satellites to provide the cell coverage area comprises a size and shape of a footprint of the respective beam at the surface of the earth at a respective elevation angle or a respective time.

10. The method of claim 8, wherein the information regarding a respective beam produced by each of the one or more satellites to provide the cell coverage area comprises an angle of the beam.

11.-12. (canceled)

13. The method of claim 1, wherein the received information comprises at least one of:
one or more cell coverage area descriptions with associated time stamps;
a reference cell coverage area along with information from which an associated satellite elevation angle can be determined;
a reference satellite elevation angle along with information from which an associated reference cell coverage area or an associated reference satellite beam footprint can be determined;
a center location of the cell coverage area;
a solid angle of a satellite beam representing a non-interfered cell coverage area;
a solid angle of a plurality of satellite beams whose combined footprint represents a non-interfered cell area;
a solid angle of each satellite beam in a plurality of beams whose combined footprint represents a non-interfered cell coverage area;
a direction of a satellite beam, whose footprint represents a non-interfered cell coverage area;
a direction of a bundle of satellite beams whose combined footprint represents a non-interfered cell coverage area;
a direction of each satellite beam in a bundle of beams whose combined footprint represents a non-interfered cell coverage area; and
satellite ephemeris data.

14.-16. (canceled)

17. The method of claim 1, and further comprising determining a time the wireless device can expect to be covered by a cell defined by the cell coverage area.

18. (canceled)

19. The method of claim 1, and further comprising determining which of a plurality of cells may be suitable for a certain mobility operation.

20. The method of claim 1, and further comprising using the cell coverage area in effecting a cell selection procedure.

21.-34. (canceled)

35. A wireless device for determining cell coverage area provided by one or more satellites, the wireless device adapted to:
receive information at the wireless device; and
obtain, by the wireless device using the received information, a location of the cell coverage area provided by the one or more satellites for a plurality of times.

36. (canceled)

37. The wireless device of claim 35, wherein the received information specifies how a shape of the cell coverage area provided by the one or more satellites varies with time.

38. The wireless device of claim 35, further adapted to determine, based on the received information, how a shape of the cell coverage area provided by the one or more satellites varies with time.

39. The wireless device of claim 38, wherein the received information includes a plurality of shape descriptions of the cell coverage area provided by one or more satellites at respective times.

40.-41. (canceled)

42. The wireless device of claim 35, wherein the received information comprises ephemeris data of the one or more satellites and information regarding a respective beam produced by each of the one or more satellites to provide the cell coverage area.

43. The wireless device of claim 42, wherein the information regarding a respective beam produced by each of the one or more satellites to provide the cell coverage area comprises a size and shape of a footprint of the respective beam at the surface of the earth at a respective elevation angle or a respective time.

44. The wireless device of claim 42, wherein the information regarding a respective beam produced by each of the one or more satellites to provide the cell coverage area comprises an angle of the beam.

45.-50. (canceled)

51. The wireless device of claim 35, further adapted to determine a time the wireless device can expect to be covered by a cell defined by the cell coverage area.

52. (canceled)

53. The wireless device of claim 35, further adapted to determine which of a plurality of cells may be suitable for a certain mobility operation.

54. The wireless device of claim 35, further adapted to use the cell coverage area in effecting a cell selection procedure.

55.-68. (canceled)
